(19) United States
(12) Patent Application Publication
(10) Pub. No.: US 2020/0208552 A1
(43) Pub. Date: Jul. 2, 2020

(54) ENGINE

(71) Applicant: KUBOTA Corporation, Osaka (JP)

(72) Inventors: Satoshi SUGIMOTO, Osaka (JP); Yusuke KOMEMUSHI, Osaka (JP); Shinya ASADA, Osaka (JP); Takayasu OGUSHI, Osaka (JP)

(21) Appl. No.: 16/658,935

(22) Filed: Oct. 21, 2019

(30) Foreign Application Priority Data
Dec. 31, 2018 (JP) 2018-248836
Dec. 31, 2018 (JP) 2018-248837

(51) Int. Cl. F01M 13/00; F01M 13/04

(52) U.S. Cl. CPC F01M 13/0011; F02F 7/00; F01M 13/0416

(57) ABSTRACT

An engine is provided where oil is minimally blown off through a breather chamber. The breather chamber includes a plurality of breather inlet chambers each having a breather inlet which opens on a bottom wall; an oil separation chamber where blow-by gases flown out from the breather inlet chambers merge together and oil separation is performed; and a breather outlet. A ceiling wall of each breather inlet chamber is lower than a ceiling wall of an oil separation chamber. It is preferable that the respective breather inlet chambers each have: a remote-side chamber portion disposed remote from the oil separation chamber and a near-side chamber portion disposed near to the oil separation chamber. A ceiling wall of the near-side chamber portion is disposed lower than a ceiling wall of the remote-side chamber portion with a stepped portion formed between the ceiling wall and the ceiling wall.

### BACKGROUND OF THE INVENTION

### (1) Field of the Invention

The present invention relates to an engine.

### (2) Description of Related Art

In a conventional engine, there is no difference in height between a ceiling wall of a breather inlet chamber of a breather chamber and a ceiling wall of an oil separation chamber. Accordingly, the height of the ceiling wall of the breather inlet chamber is relatively high and hence, a blow-by gas which flows into the breather chamber through a breather inlet minimally impinges on the ceiling wall. As a result, a preliminary oil separation brought about by condensation of oil mist in the breather inlet chamber cannot be expected. Accordingly, oil mist contained in the blow-by gas is not sufficiently separated so that oil is easily blown off through the breather chamber.

### SUMMARY OF THE INVENTION

It is an object of the present invention to provide an engine where oil is minimally blown off through a breather chamber.

In the present invention, a breather chamber is provided. The breather chamber includes a plurality of breather inlet chambers and an oil separation chamber. A ceiling wall of each breather inlet chamber is lower than a ceiling wall of the oil separation chamber.

According to the present invention, oil is minimally blown-off through the breather chamber.

Further, condensation of the oil mist is accelerated.

Still further, a passage resistance of the breather chamber (1) can be reduced.

### BRIEF DESCRIPTION OF THE DRAWINGS

FIGS. 1A and 1B are views for describing a basic example of a breather chamber of an engine according to an embodiment of the present invention, wherein FIG. 1A is a transverse cross-sectional plan view, and FIG. 1B is a cross-sectional view taken along a line B-B in FIG. 1A.

FIG. 2 is a vertical cross-sectional view of a main part of an engine including a breather chamber shown in FIGS. 1A and 1B.

FIG. 3 is an exploded perspective view of the main part of the engine including the breather chamber shown in FIGS. 1A and 1B.

FIGS. 4A and 4B are views for describing a modification of the breather chamber, wherein FIG. 4A is a transverse cross-sectional plan view, and FIG. 4B is a cross-sectional view taken along a line B-B in FIG. 4A.

### DETAILED DESCRIPTION OF PREFERRED EMBODIMENTS

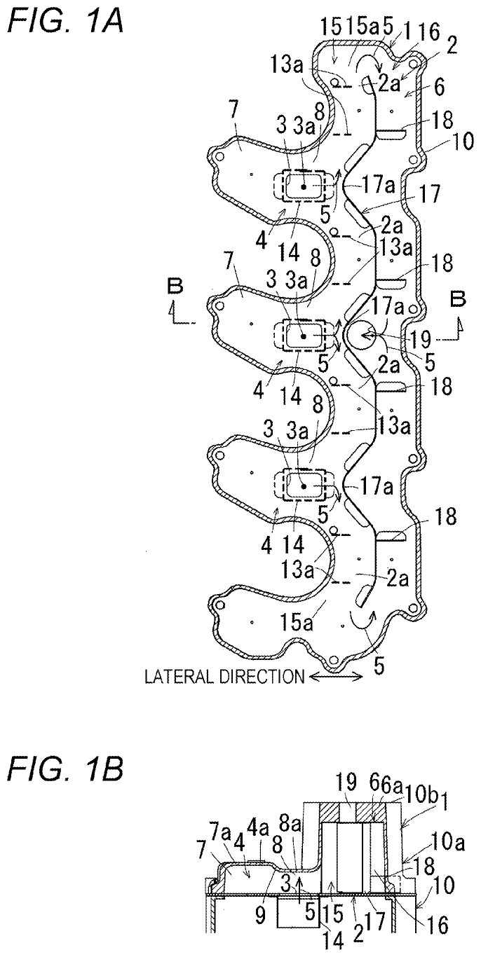

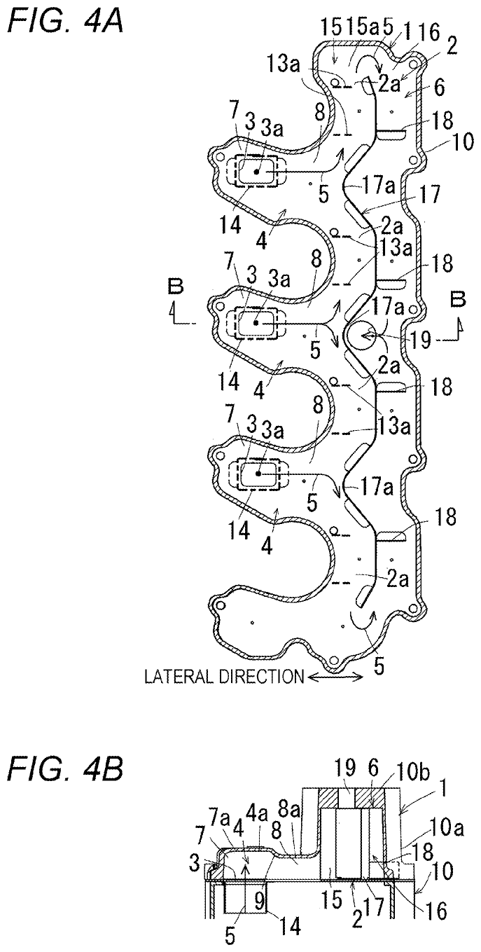

FIG. 1A to FIG. 3 are views for describing a basic example of a breather chamber of the engine according to the embodiment of the present invention, FIGS. 4A and 4B are views for describing a modification of the breather chamber. In this embodiment, the description is made with respect to a vertical-type in-line multiple cylinder diesel engine.

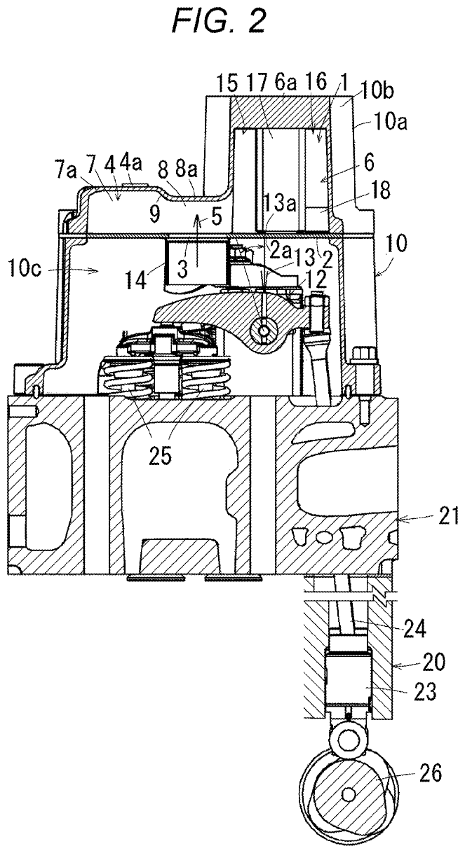

As shown in FIG. 2, the engine includes: a cylinder block (20); a cylinder head (21) which is assembled to an upper portion of the cylinder block (20); and a cylinder head cover (10) which is assembled to an upper portion of the cylinder head (21).

The engine includes a valve operating device (22), and a breather chamber (1).

The valve operating device (22) performs a valve opening operation of an exhaust valve (25) and an intake valve (not shown in the drawing) by way of a valve operating cam (26), a tappet (23), a pushing rod (24), and a rocker arm (12) in this order.

The breather chamber (1) communicates with a rocker arm chamber (10c) in the cylinder head cover (10).

As shown in all drawings, the engine includes the breather chamber (1).

As shown in FIGS. 1A and 1B and FIGS. 4A and 4B, the breather chamber (1) includes: a plurality of breather inlet chambers (4) each having a breather inlet (3) which opens in a bottom wall (2); an oil separation chamber (6) where blow-by gases (5) flown out from the plurality of breather inlet chambers (4) merge together and oil separation is performed; and a breather outlet (19).

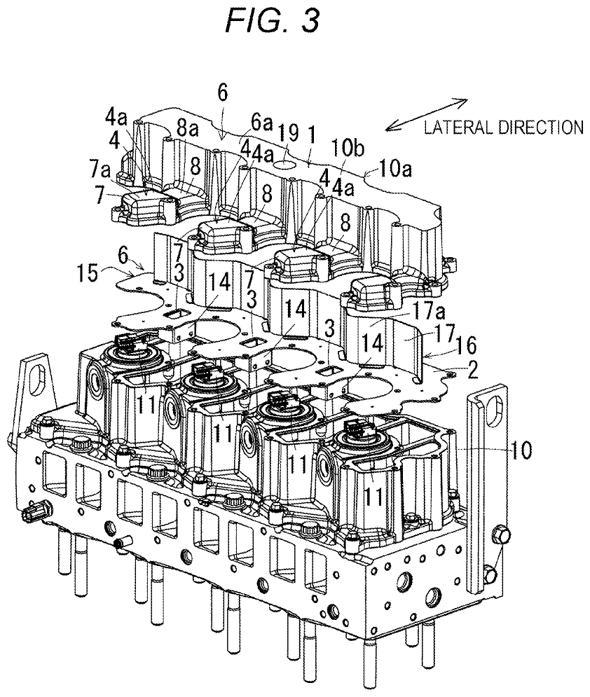

As shown in FIG. 1B, FIG. 2, FIG. 3 and FIG. 4B, ceiling walls (4a) of the respective breather inlet chambers (4) are set lower than a ceiling wall (6a) of the oil separation chamber (6).

Accordingly, this engine can acquire the above-mentioned advantageous effects of the present invention.

As shown in all drawings, the respective breather inlet chambers (4) each have: a remote-side chamber portion (7) which is disposed remote from the oil separation chamber (6); and a near-side chamber portion (8) which is disposed near the oil separation chamber (6). A ceiling wall (8a) of the near-side chamber portion (8) is disposed lower than a ceiling wall (7a) of the remote-side chamber portion (7) with a stepped portion (9) formed between the ceiling wall (8a) and the ceiling wall (7a).

In the engine, an oil which is condensed on the ceiling wall (7a) of the remote-side chamber portion (7) shown in FIG. 1B, FIG. 3 and FIG. 4B is blocked by the stepped portion (9) so that the flow of oil is stopped and hence, the breather inlet chamber (4) can acquire a high oil separation performance.

In the basic example shown in FIG. 1A to FIG. 3, the breather inlet (3) is opened at the near-side chamber portion (8). However, in the modification shown in FIGS. 4A and 4B, the breather inlet (3) is opened at the remote-side chamber portion (7).

As shown in FIG. 1B, FIG. 2, FIG. 3 and FIG. 4B, the engine is characterized by the following technical features. The breather chamber (1) is formed in a ceiling portion (10a) of the cylinder head cover (10).

As shown in all drawings, in a state where an engine width direction is set as a lateral direction, the breather inlet chambers (4) extend sideward from the oil separation chamber (6).

As shown in FIG. 3, a connector (11) of a wire harness of a fuel injector is disposed between a pair of breather inlet chambers (4) which are disposed adjacently to each other in a crankshaft extending direction.

In this engine, a foreign substance which approaches the connector (11) shown in FIG. 3 is received by the oil separation chamber (6) having a large height and walls of the pair of breather inlet chambers (4) which sandwiches the connector (11) therebetween. Accordingly, it is possible to prevent the foreign substance from impinging on the connector (11).

As shown in FIG. 3, the breather chamber (1) is formed between a ceiling wall (10b) of the cylinder head cover (10) which houses the rocker arm (12) and the bottom wall (2) which opposedly faces the ceiling wall (10b).

The bottom wall (2) includes: a plurality of oil receiving wall portions (2a) shown in FIG. 1A and FIG. 4A which receive an injection oil (13) injected upward from the rocker arm (12) shown in FIG. 2; and the breather inlets (3) which are opened at positions avoiding the oil receiving wall portions (2a).

In this engine, the injection oil (13) which is injected upward from the rocker arm (12) shown in FIG. 2 minimally enters the breather chamber (1) through the breather inlets (3) so that an oil is minimally blown off through the breather chamber (1).

As shown in FIG. 1A and FIG. 4A, in a state where the engine width direction is set as the lateral direction, the breather inlet (3) is opened at a position displaced from the oil receiving wall portion (2a) in an obliquely sideward direction.

In this engine, even when an impingement position (13a) of the injection oil (13) at the oil receiving wall portion (2a) shown in FIG. 1A, FIG. 3 and FIG. 4A is changed due to rocking of the rocker arm (12) shown in FIG. 2 or blowing off of the blow-by gas (5), the injection oil (13) minimally enters the breather inlets (3).

As shown in FIG. 1A and FIG. 4A, the bottom wall (2) of the breather chamber (1) includes cylindrical oil receiving frames (14) which extend downward from peripheral portions of the breather inlets (3).

In this engine, a condensed oil which is blown off by the blow-by gas (5) on a lower surface of the bottom wall (2) of the breather chamber (1) is received by the oil receiving frames (14) and hence, the condensed oil minimally enters the breather inlets (3).

As shown in FIG. 1A and FIG. 4A, the oil separation chamber (6) includes: a blow-by gas merging passage (15) where blow-by gasses (5) flown out from the plurality of breather inlet chambers (4) merge together; a blow-by gas detour passage (16) which guides the blow-by gas (5) in the blow-by gas merging passage (15) to the breather outlet (19) by detouring the blow-by gas (5); and a passage partition wall (17) by which the blow-by gas merging passage (15) and the blow-by gas detour passage (16) are separated from each other.

In this engine, oil mist contained in the blow-by gas (5) is condensed in a long passage formed in the oil separation chamber (6) and hence, the oil separation chamber (6) can acquire a high oil separation performance.

Further, in this engine, as shown in FIG. 1B, FIG. 2 and FIG. 4B, the oil separation chamber (6) having a large height can have a relatively large passage cross-sectional area even when the oil separation chamber (6) is partitioned by the passage partition wall (17). Accordingly, a passage resistance of the breather chamber (1) can be reduced.

As shown in FIG. 1A, FIG. 3 and FIG. 4A, the passage partition wall (17) includes bent wall portions (17a).

In this engine, the blow-by gas (5) which passes through the long passage impinges on surfaces of the bent wall portions (17a) so that oil mist is condensed efficiently and hence, the oil separation chamber (6) can acquire a high oil separation performance.

As shown in FIG. 1A, FIG. 3 and FIG. 4A, the bent wall portions (17a) protrude toward the breather inlet (3) side respectively in the blow-by gas merging passage (15).

In this engine, as shown in FIG. 1A and FIG. 4A, the blow-by gas (5) which flows in the breather chamber (1) from the breather inlet (3) impinges on the bent wall portions (17a) close to the breather inlets (3) at a high speed so that condensation of oil mist contained in the blow-by gas (5) is accelerated whereby the blow-by gas merging passage (15) can acquire a high oil separation performance.

As shown in FIG. 1A and FIG. 4A, as viewed in a direction parallel to a center axis (3a) of the breather inlet (3), the bent wall portion (17a) is formed in a V shape where a width is gradually narrowed toward the breather inlet (3) side.

In this engine, the respective blow-by gasses (5) which flow into the breather chamber (1) through the plurality of breather inlets (3) advance in the oil separation chamber (6) in a meandering manner by being guided by the V-shaped bent walls, and impinge on each other in a crossing manner, and small oil droplets in the oil mist contained in the blow-by gas are merged together thus forming large oil droplets, and the large oil droplets fall down and are condensed. Accordingly, the oil separation chamber (6) can acquire a high oil separation performance.

As shown in FIG. 1A and FIG. 4A, the breather chamber (1) includes a pair of merging passage outlets (15a), (15a) which are provided on both end sides of the passage partition wall (17), the blow-by gas merging passage (15) communicates with both end sides of the blow-by gas detour passage (16) through the respective merging passage outlets (15a) on both end side of the blow-by gas merging passage (15), and the breather outlet (19) is disposed on a center portion of the blow-by gas detour passage (16) in a longitudinal direction of the blow-by gas detour passage (16).

In this engine, the pair of blow-by gasses (5) which is distributed by the pair of merging chamber outlets (15a), (15a) flow out through the breather outlet (19) from the blow-by gas detour passage (16) by way of the equal detour distance respectively. Accordingly, the blow-by gasses (5) can make use of the oil separation performance of the blow-by gas detour passage (16) without either excess or insufficiency and hence, the blow-by gas detour passage (16) exhibits a high oil separation performance.

As shown in FIG. 1B, FIG. 2 and FIG. 4B, the blow-by gas detour passage (16) includes baffle plates (18) which stand upright from the bottom wall (2).

In this engine, the blow-by gas (5) which passes through the blow-by gas detour passage (16) impinges on the baffle plates (18) and hence, the oil mist contained in the blow-by gas (5) is condensed on surfaces of the baffle plates (18). Accordingly, the blow-by gas detour passage (16) can acquire a high oil separation performance.

Further, according to the present invention, even when the condensed oil accumulated on the bottom wall (2) of the blow-by gas detour passage (16) is blown off by the blow-by gas (5), the condensed oil is received by the baffle plates (18) and hence, the oil is minimally formed into mist again. Accordingly, it is possible to suppress the occurrence of a phenomenon that the condensed oil is formed into mist again in the blow-by gas detour passage (16).

Further, according to the present invention, even when the baffle plates (18) stand upright from the bottom wall (2) of the blow-by gas detour passage (16), in the oil separation chamber (6) which has the relatively high ceiling wall (6a), the blow-by gas detour passage (16) can acquire a relatively large passage cross-sectional area and hence, a passage resistance of the breather chamber (1) can be reduced.

What is claimed is:

1. An engine comprising a breather chamber, wherein
the breather chamber includes: a plurality of breather inlet chambers each having a breather inlet which opens on a bottom wall; an oil separation chamber where blow-by gases flown out from the plurality of breather inlet chambers merge together and oil separation is performed; and a breather outlet, wherein
a ceiling wall of each breather inlet chamber is lower than a ceiling wall of an oil separation chamber.

2. The engine according to claim 1, wherein the respective breather inlet chambers each have: a remote-side chamber portion which is disposed remote from the oil separation chamber; and a near-side chamber portion which is disposed near the oil separation chamber, and a ceiling wall of the near-side chamber portion is disposed lower than a ceiling wall of the remote-side chamber portion with a stepped portion formed between the ceiling wall and the ceiling wall.

3. The engine according to claim 2, wherein
the breather chamber is formed in a ceiling portion of the cylinder head cover,
the breather inlet chambers extend sideward from the oil separation chamber in a state where an engine width direction is set as a lateral direction, and
a connector of a wire harness of a fuel injector is disposed between a pair of breather inlet chambers which is disposed adjacently to each other in a crankshaft extending direction.

4. The engine according to claim 1, wherein
the breather chamber is formed between a ceiling wall of the cylinder head cover which houses a rocker arm and the bottom wall which opposedly faces the ceiling wall, and
the bottom wall includes: a plurality of oil receiving wall portions which receive an injection oil injected upward from the rocker arm; and breather inlets which open at positions avoiding the oil receiving wall portions.

5. The engine according to claim 2, wherein
the breather chamber is formed between a ceiling wall of the cylinder head cover which houses a rocker arm and the bottom wall which opposedly faces the ceiling wall, and
the bottom wall includes: a plurality of oil receiving wall portions which receive an injection oil injected upward from the rocker arm; and breather inlets which open at positions avoiding the oil receiving wall portions.

6. The engine according to claim 3, wherein
the breather chamber is formed between a ceiling wall of the cylinder head cover which houses a rocker arm and the bottom wall which opposedly faces the ceiling wall, and
the bottom wall includes: a plurality of oil receiving wall portions which receive an injection oil injected upward from the rocker arm; and breather inlets which open at positions avoiding the oil receiving wall portions.

7. The engine according to claim 4, wherein the breather inlet is opened at a position displaced from the oil receiving wall portion in an obliquely sideward direction in a state where an engine width direction is set as a lateral direction.

8. The engine according to claim 5, wherein the breather inlet is opened at a position displaced from the oil receiving wall portion in an obliquely sideward direction in a state where an engine width direction is set as a lateral direction.

9. The engine according to claim 6, wherein the breather inlet is opened at a position displaced from the oil receiving wall portion in an obliquely sideward direction in a state where an engine width direction is set as a lateral direction.

10. The engine according to claim 4, wherein the bottom wall of the breather chamber includes a cylindrical oil receiving frame which extends downward from a peripheral portion of the breather inlet.

11. The engine according to claim 5, wherein the bottom wall of the breather chamber includes a cylindrical oil receiving frame which extends downward from a peripheral portion of the breather inlet.

12. The engine according to claim 6, wherein the bottom wall of the breather chamber includes a cylindrical oil receiving frame which extends downward from a peripheral portion of the breather inlet.

13. The engine according to claim 1, wherein the oil separation chamber includes:
a blow-by gas merging passage where blow-by gases flown out from the plurality of breather inlet chambers merge together; a blow-by gas detour passage which guides the blow-by gas in the blow-by gas merging passage to a breather outlet by detouring the blow-by gas; and a passage partition wall by which the blow-by gas merging passage and the blow-by gas detour passage are separated from each other.

14. The engine according to claim 2, wherein the oil separation chamber includes:
a blow-by gas merging passage where blow-by gases flown out from the plurality of breather inlet chambers merge together; a blow-by gas detour passage which guides the blow-by gas in the blow-by gas merging passage to a breather outlet by detouring the blow-by gas; and a passage partition wall by which the blow-by gas merging passage and the blow-by gas detour passage are separated from each other.

15. The engine according to claim 3, wherein the oil separation chamber includes:
a blow-by gas merging passage where blow-by gases flown out from the plurality of breather inlet chambers merge together; a blow-by gas detour passage which guides the blow-by gas in the blow-by gas merging passage to a breather outlet by detouring the blow-by gas; and a passage partition wall by which the blow-by gas merging passage and the blow-by gas detour passage are separated from each other.

16. The engine according to claim 13, wherein the passage partition wall includes a bent wall portion.

17. The engine according to claim 16, wherein the bent wall portion protrudes toward the breather inlet side in the blow-by gas merging passage.

18. The engine according to claim 17, wherein, as viewed in a direction parallel to a center axis of the breather inlet, the bent wall portion is formed in a V shape where a width is gradually narrowed toward a breather inlet side.

19. The engine according to claim 13, wherein the breather chamber includes a pair of merging passage outlets disposed on both end sides of the passage partition wall, the blow-by gas merging passage communicates with both end sides of the blow-by gas detour passage through the respective merging passage outlets on the both end sides, and the breather outlet is disposed at a center portion of the blow-by gas detour passage in a longitudinal direction of the blow-by gas detour passage.

20. The engine according to claim 13, wherein the blow-by gas detour passage includes a baffle plate which stands upright from the bottom wall.
